(19) United States
(12) Patent Application Publication
(10) Pub. No.: US 2012/0246686 A1
(43) Pub. Date: Sep. 27, 2012

(54) Mobile Terminal and Sleep Method in MBBMS Module of Mobile Terminal

(75) Inventor: Jinguang Dong, Shenzhen City (CN)

(73) Assignee: ZTE Corporation, Shenzhen City, Guangdong Province (CN)

(21) Appl. No.: 13/260,085

(22) PCT Filed: Jun. 24, 2010
(86) PCT No.: PCT/CN2010/074410

§ 371 Date: May 16, 2012

(30) Foreign Application Priority Data
Dec. 11, 2009 (CN) 200910254331.7

(51) Int. Cl. H04N 21/60

(52) U.S. Cl. 725/62

(57) ABSTRACT

The present invention provides a mobile terminal and a method for dormancy of a mobile broadcast business management system (MBBMS) module in the mobile terminal. The method comprises: before the MBBMS module enters into dormancy, extracting working state information and firmware information of the MBBMS module and storing the working state information and firmware information into a non-volatile memory in a form of file; and after the MBBMS module is awakened, reading the working state information and firmware information from the non-volatile memory, configuring the MBBMS module based on the working state information and firmware information and restoring working context of the MBBMS module.

### TECHNICAL FIELD

The present invention relates to the field of mobile communication, and more particularly, to a mobile terminal and a method for dormancy of an MBBMS module in the mobile terminal.

### BACKGROUND OF THE RELATED ART

A Mobile Broadcast Business Management System (MBBMS) is a handheld mobile device carrying a mobile phone TV function of the MBBMS such that mobile phone TV is watched just as broadcast is listened, and is very convenient to use.

The MBBMS implements operability and manageability of broadcast mobile phone TV services. The basis of the MBBMS is to manage mobile phone TV users using management and charging systems and certification and authentication mechanisms of the existing mobile communication networks. The MBBMS can carry not only telecommunication standards, such as Terrestrial Mobile Multimedia Broadcasting (TMMB), time division synchronous code division multiple access (TD-SCDMA), multimedia broadcast system (TD-MBMS), but also China mobile multimedia broadcasting (CMMB).

Since the MBBMS technology is an emerging technology, maturity of chips related to the MBBMS in the market remains to be improved. If a chip stops working, the related internally running firmware and current working state information will be lost. When a mobile terminal enters into a standby mode and is then awakened, this defect will result in loss of the related information of users, such as the currently played program list and firmware, bringing great inconvenience to the users.

For this defect, a most common method is that when a mobile phone enters a dormancy state, a Power Manage Unit (PMU) always maintains power on of a MBBMS module such that it is in a working state. That is to say, the MBBMS does not enter the standby dormancy state. The drawback of such a method is quite apparent, i.e. standby using time of a battery is reduced. Because the MBBMS module is still maintained in the working state when a user selects to cause the terminal to enter into dormancy, electricity of the battery is consumed meaninglessly, resulting in the using time of the battery being shortened greatly and user experience being decreased.

### CONTENT OF THE INVENTION

A technical problem to be solved by the present invention is to provide a mobile terminal and a method for dormancy of a MBBMS module in the mobile terminal so as to effectively utilize a battery and support longer standby using time.

In order to solve the above technical problem, the present invention provides a method for dormancy of a mobile broadcast business management system (MBBMS) module in a mobile terminal comprising:

before the MBBMS module enters into dormancy, extracting working state information and firmware information of the MBBMS module and storing the working state information and firmware information into a non-volatile memory in a form of file; and after the MBBMS module is awakened, reading the working state information and firmware information from the non-volatile memory, configuring the MBBMS module based on the working state information and firmware information and restoring working context of the MBBMS module.

Preferably, the method further comprises:

Pre-creating a state information backup table;

in the step of extracting the working state information and firmware information of the MBBMS module and storing the working state information and firmware information into the non-volatile memory in the form of file, storing the extracted working state information and firmware information into the state information backup table, and storing the state information backup table into the non-volatile memory of the mobile terminal in the form of file.

Preferably, the working state information contains mobile phone TV channel frequency point information and channel list information.

Preferably, the state information backup table further contains program channel frequency point information favored by a user and system timestamp created when the state information backup table is updated.

Preferably, the step of configuring the MBBMS module based on the working state information and firmware information and restoring the working context of the MBBMS module comprises: loading the mobile phone TV channel frequency point information, channel list information and firmware information into the MBBMS module.

In order to solve the above technical problem, the present invention further provides a mobile terminal for implementing dormancy of a mobile broadcast business management system (MBBMS) module comprising: an extracting module, a storage module and an initialization module, wherein

the extracting module is configured to, before the MBBMS module enters into dormancy, extract working state information and firmware information of the MBBMS module and store the working state information and firmware information into the storage module;

the storage module is a non-volatile memory and configured to store the working state information and firmware information in a form of file; and

the initialization module is configured to, after the MBBMS module is awakened, read the working state information and firmware information from the non-volatile memory, configure the MBBMS module based on the working state information and firmware information, and restore work context of the MBBMS module.

Preferably, the extracting module is configured to store the working state information and firmware information into a state information backup table, and store the state information backup table into the storage module in the form of file.

The working state information contains mobile phone TV channel frequency point information and channel list information.

Preferably, the state information backup table further contains program channel frequency point information favored by a user and system timestamp created when the state information backup table is updated.

Preferably, the initialization module is configured to, after the MBBMS module is awakened, read the working state information and firmware information from the non-volatile memory, and load the mobile phone TV channel frequency point information, channel list information and firmware information into the MBBMS module.

Preferably, the mobile terminal further comprises a determination module connected to the extracting module and the initialization module and configured to trigger the extracting module when determining that the MBBMS module enters into dormancy and trigger the initialization module when determining that the MBBMS module is awakened.

In the present invention, on the premise that the hardware framework of the existing MBBMS mobile phone hardware is not changed, only a software (backup state information backup table) method is required to achieve standby power saving function of the MBBMS terminal, thereby overcoming the defect in the related art that the MBBMS module has no dormancy function. The method in accordance with the present invention prolongs standby using time of the mobile phone while effectively improving user experience of the user using the MBBMS mobile phone TV services such that the mobile terminal can support standby and awaking of the MBBMS module without hardware dormancy function and use the battery more effectively, thereby decreasing power consumption of the battery and prolonging the standby using time of the mobile phone. The present invention is not only suitable for a MBBMS module which does not support the standby function but also applied to a MBBMS module which supports the standby function so as to save power better.

### BRIEF DESCRIPTION OF DRAWINGS

FIG. 1 is a flowchart of a dormancy process according to an embodiment of the present invention;

FIG. 2 is a flowchart of an awaking process according to an embodiment of the present invention;

FIG. 3 is a flowchart of a process for implementing a state information backup table according to an embodiment of the present invention; and

FIG. 4 is a block diagram of a mobile terminal according to an embodiment of the present invention.

### PREFERRED EMBODIMENTS OF THE PRESENT INVENTION

In the present invention, backup and acquisition of information are combined into a method for dormancy of a MBBMS to improve user experience, and state information is stored into a non-volatile memory such that loss of related information can be avoided, even though a battery of a mobile phone is powered off or plugged out abnormally.

The inventive concept of the present invention is to extract working state information and firmware information of the MBBMS module before the MBBMS module enters into dormancy and store the working state information and firmware information into a non-volatile memory in a form of file, and read the working state information and firmware information from the non-volatile memory after the MBBMS module is awakened, configure the MBBMS module based on the working state information and firmware information and restore working context of the MBBMS module. Thus, the working state information of the MBBMS module prior to dormancy can be ensured not to be lost.

Restoring the working context means that mobile phone TV channel frequency point information, channel list information and firmware information are loaded into the MBBMS module.

A state information backup table is pre-created in a non-volatile memory of a mobile terminal for storing the working state information and firmware information.

Particularly, a state information backup table is pre-created in the mobile terminal; when the MBBMS module of the mobile terminal needs dormancy, the current working state information of the MBBMS module and the firmware information of the MBBMS module are stored in the state information backup table and the state information backup table is stored in the non-volatile memory (such as flash memory) of the mobile terminal, and the MBBMS module is switched off. When a user needs to use mobile phone TV services, the MBBMS module is powered on, the working state information and firmware information are read out from the state information backup table, and the MBBMS module is reconfigured based on the working state information and firmware information.

The working state information contains mainly mobile phone TV channel frequency point information and channel list information. The firmware information of the MBBMS module mainly refers to the firmware version of the MBBMS module, the size of which is about 64 KB.

The state information backup table may further contain program channel frequency point information favored by the user and system timestamp created when the state information backup table is updated.

The mobile terminal reconfiguring the MBBMS module based on the state information backup table comprises: reloading the firmware version of the MBBMS module and configuring the MBBMS module based on the mobile phone TV channel frequency point information and channel list information to restore the working state information stored prior to last dormancy.

The present invention will be described in detail below in conjunction with the accompanying drawings and particular implementation steps.

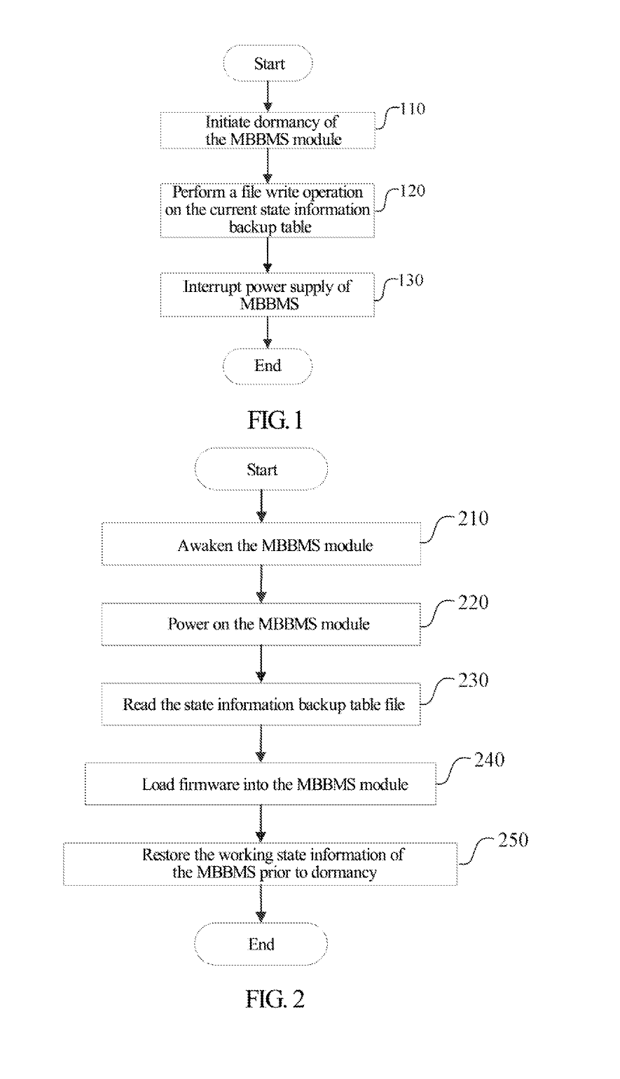

As shown in FIG. 1, a process where a MBBMS module enters into dormancy comprises the following steps.

In step 110, dormancy of the MBBMS module is initiated and a dormancy instruction is sent out.

The dormancy instruction, for example, may be an instruction of exiting a mobile phone TV play menu or an instruction for the mobile phone to enter into a standby mode.

In step 120, a control module of the mobile terminal is switched on or a state information backup table is created, a file write operation is performed on the current channel frequency point, play channel list, firmware information of the MBBMS module, and the state information backup table is stored into a state information backup table file.

In step 130, the control module of the mobile terminal processes power failure of the MBBMS module.

Power failure of the MBBMS module can be processed using an underlying drive interface.

As shown in FIG. 2, an awaking process of a MBBMS module comprises the following steps.

In step 210, an awaking instruction is initiated.

The awaking instruction, for example, may be an instruction sent by a user when viewing television programs using the MBBMS module.

In step 220, the MBBMS module is powered on by the control module of the mobile terminal.

In step 230, the control module of the mobile terminal performs a file read operation on working state information stored last time in the state information backup table file, and extracts the working state information and firmware information of the MBBMS module from the state information backup table.

In step 240, the MBBMS module is initialized using the firmware information, and firmware is obtained from the state information backup table file and loaded into the MBBMS module.

In step 250, the MBBMS module is initialized using the working state information, the MBBMS module is configured based on the stored working state information and the channel frequency point information and channel list information prior to dormancy are restored.

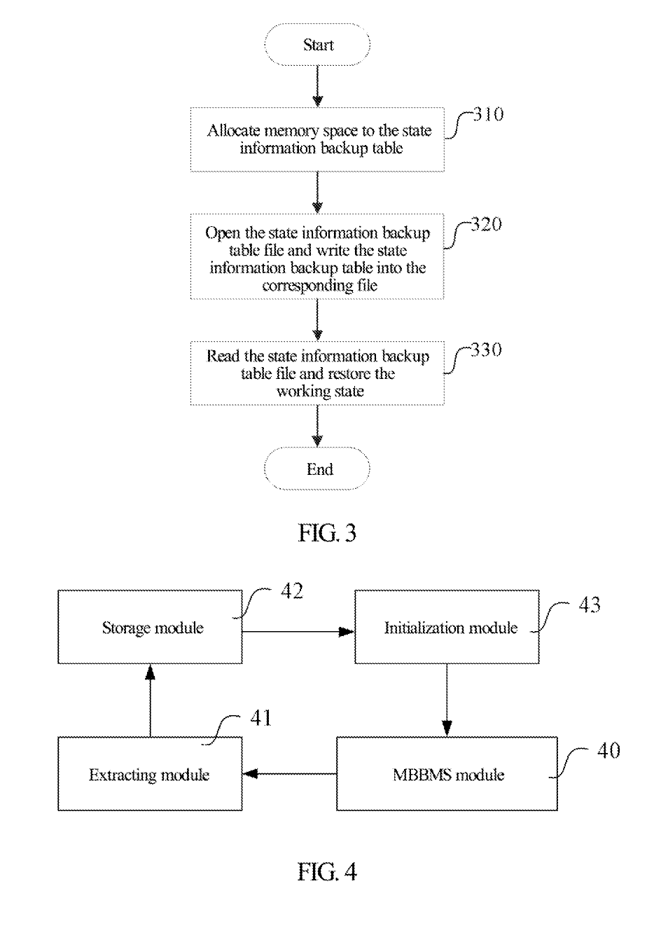

As shown in FIG. 3, the implementation of the state information backup table is as follows.

In step 310, corresponding space is allocated to the state information backup table required to be stored, such as firmware version, frequency point, current play program, etc.

The state information backup table is stored in the state information backup table file on the mobile terminal. When the MBBMS module needs dormancy, the state information backup table is used for storing the current working state information of the MBBMS module and the firmware information of the MBBMS module; and when MBBMS module needs to be awaken, the state information backup table is used for providing the working state information to the MBBMS module so as to restore it.

In step 320, when the user exits mobile phone TV services and the MBBMS module need to enter into dormancy, the state information backup table is opened (or created) to write the working state information and firmware information, and the working state information backup table is written into the state information backup table file.

The state information backup table refers to a memory space created in memory spaces, and the state information backup table file refers to a file created in a file system and is non-volatile.

In step 330, when the user starts the mobile phone TV services and the MBBMS module is required to be awakened, the control module opens the working state information backup table and takes out the working state information backup table from the working state information backup table file and restores the working state.

As shown in FIG. 4, a mobile terminal implementing dormancy of a MBBMS module 40 comprises an extracting module 41, a storage module 42 and an initialization module 43.

The extracting module is configured to, before the MBBMS module enters into dormancy, extract working state information and firmware information of the MBBMS module and store the working state information and firmware information into the storage module.

The storage module is a non-volatile memory and configured to store the working state information and firmware information in a form of file.

The initialization module is configured to, after the MBBMS module is awakened, read the working state information and firmware information from the storage module, configure the MBBMS module based on the working state information and firmware information, and restore their work context.

Preferably, the initialization module is configured to, after the MBBMS module is awakened, read the working state information and firmware information from the storage module, and load mobile phone TV channel frequency point information, channel list information and firmware information into the MBBMS module.

Preferably, the mobile terminal further comprises a determination module connected to the extracting module and the initialization module and configured to trigger the extracting module when determining that the MBBMS module enters into dormancy and trigger the initialization module when determining that the MBBMS module is awakened.

In the present invention, the approach of storing the working state information and firmware information of the MBBMS module prior dormancy can be used to implement standby power saving function of the MBBMS terminal, improving effectively user experience of the user using the MBBMS mobile phone TV services and prolonging standby using time of the mobile phone, such that the mobile terminal can support standby and awaking of the MBBMS module without hardware dormancy function and use the battery more effectively, thereby decreasing power consumption of the battery and prolonging the standby using time of the mobile phone.

It may be understood by those skilled in the art that all or some of the steps in the described method can be implemented by related hardware instructed by programs which may be stored in computer readable storage mediums, such as read-only memory, disk or CD-ROM, etc. Alternatively, all or some of the steps in the embodiments described above may also be implemented using one or more integrated circuits. Accordingly, each module/unit in the embodiments described above may be implemented in a form of hardware, or software functional module. The present invention is not limited to combinations of hardware and software in any particular form.

The present invention can be implemented by the method described above. Of course, other various embodiments may be possible. Various corresponding changes and variations to the present invention may be made by those skilled in the art without departing from the spirit and essence of the present invention. However, all of the corresponding changes should fall into the protection scope of the appended claims of the present invention.

### INDUSTRIAL APPLICABILITY

In the mobile terminal and the method for dormancy of the MBBMS module in the mobile terminal in accordance with the present invention, the approach of storing the working state information and firmware information of the MBBMS module prior to dormancy can be used to implement the standby power saving function of the MBBMS terminal, improving effectively and user experience of the user using the MBBMS mobile phone TV services and prolonging standby using time of the mobile phone, such that the mobile terminal can support standby and awaking of the MBBMS module without hardware dormancy function and use the battery more effectively, thereby decreasing power consumption of the battery. In addition, the method described above is not only suitable for a MBBMS module which does not support the standby function but also applied to a MBBMS module which supports the standby function, and its applications are wide.

1. A method for dormancy of a mobile broadcast business management system (MBBMS) module in a mobile terminal comprising:
before the MBBMS module enters into dormancy, extracting working state information and firmware information of the MBBMS module and storing the working state information and firmware information into a non-volatile memory in a form of file; and after the MBBMS module is awakened, reading the working state information and firmware information from the non-volatile memory, configuring the MBBMS module based on the working state information and firmware information and restoring working context of the MBBMS module.

2. The method according to claim 1, further comprising:
Pre-creating a state information backup table; and
in the step of extracting the working state information and firmware information of the MBBMS module and storing the working state information and firmware information into the non-volatile memory in the form of file, storing the extracted working state information and firmware information into the state information backup table, and storing the state information backup table into the non-volatile memory of the mobile terminal in the form of file.

3. The method according to claim 2, wherein
the working state information contains mobile phone TV channel frequency point information and channel list information.

4. The method according to claim 2, wherein
the state information backup table further contains program channel frequency point information favored by a user and system timestamp created when the state information backup table is updated.

5. The method according to claim 3, wherein
the step of configuring the MBBMS module based on the working state information and firmware information and restoring the working context of the MBBMS module comprises:
loading the mobile phone TV channel frequency point information, channel list information and firmware information into the MBBMS module.

6. A mobile terminal for implementing dormancy of a mobile broadcast business management system (MBBMS) module comprising: an extracting module, a storage module and an initialization module, wherein
the extracting module is configured to, before the MBBMS module enters into dormancy, extract working state information and firmware information of the MBBMS module and store the working state information and firmware information into the storage module;
the storage module is a non-volatile memory and configured to store the working state information and firmware information in a form of file; and
the initialization module is configured to, after the MBBMS module is awakened, read the working state information and firmware information from the non-volatile memory, configure the MBBMS module based on the working state information and firmware information, and restore work context of the MBBMS module.

7. The mobile terminal according to claim 6, wherein the extracting module is configured to store the working state information and firmware information into a state information backup table, and store the state information backup table into the storage module in the form of file; and
the working state information contains mobile phone TV channel frequency point information and channel list information.

8. The mobile terminal according to claim 7, wherein
the state information backup table further contains program channel frequency point information favored by a user and system timestamp created when the state information backup table is updated.

9. The mobile terminal according to claim 7, wherein
the initialization module is configured to, after the MBBMS module is awakened, read the working state information and firmware information from the non-volatile memory, and load the mobile phone TV channel frequency point information, channel list information and firmware information into the MBBMS module.

10. The mobile terminal according to claim 6, wherein the mobile terminal further comprises a determination module connected to the extracting module and the initialization module and configured to trigger the extracting module when determining that the MBBMS module enters into dormancy and trigger the initialization module when determining that the MBBMS module is awakened.

11. The method according to claim 3, wherein
the state information backup table further contains program channel frequency point information favored by a user and system timestamp created when the state information backup table is updated.
